(19) United States
(12) Patent Application Publication
(10) Pub. No.: US 2014/0267680 A1
(43) Pub. Date: Sep. 18, 2014

(54) Steel Ball Inspection Method and System

(71) Applicants: Ya-Chen Hsu, Taichung City (TW); Fang-Chih Tien, Taichung City (TW); Yi-Ji Chen, Changhua County (TW)

(72) Inventors: Ya-Chen Hsu, Taichung City (TW); Fang-Chih Tien, Taichung City (TW); Yi-Ji Chen, Changhua County (TW)

(21) Appl. No.: 13/829,888

(22) Filed: Mar. 14, 2013

(51) Int. Cl. G01N 21/95; G01N 27/90

(52) U.S. Cl. CPC G01N 21/951; G01N 27/90
USPC 348/86

(57) ABSTRACT

An automatic steel ball inspection method and system are capable of inspecting surfaces and physical properties of the steel balls, and sorting out non-targeted and non-qualified steel balls. The inspection mainly includes detecting the physical properties of the steel balls by inspecting the eddy current of the steel balls, sorting out non-targeted steel balls, taking pictures of the surfaces of the steel balls with an image pickup device, comparing the pictures of the surfaces of the steel balls, and sorting out non-qualified steel balls.

### BACKGROUND OF THE INVENTION

1. Field of the Invention

The present invention relates to a steel ball inspection method and system, and more particularly to an automatic inspection method and system for inspecting surfaces and physical properties of the steel balls.

2. Description of the Prior Art

In order to reduce the friction of the motion transmission machine, the current method is to use steel ball as medium to improve transmission efficiency. Therefore, the quality of the steel ball becomes very important, and the current defect inspection items include: surface profile, roundness, surface roughness and stain, and etc.

The conventional defect inspection method is to check the surface of the steel ball which is placed under the light with naked eyes or with low power magnifiers. However, people's eyes will become tired after staring at the ball for a long time. Besides, human' vision is only sensitive to the width of the defect, and the defects, such as small and deep cracks, and folds, are difficult to find and very likely to be neglected. On top of that, the convention inspection method is only able to detect the outer surface of the ball based on the intensity of light reflection or classify the balls on size, but is unable to inspect the interior defect of the steel ball.

The present invention has arisen to mitigate and/or obviate the afore-described disadvantages.

### SUMMARY OF THE INVENTION

The primary objective of the present invention is to provide an automatic inspection method and system capable of inspecting surfaces and physical properties of the steel balls, and sorting out non-targeted and non-qualified steel balls.

To achieve the above objective, a steel ball inspection method in accordance with the present invention comprises the following steps:

a feeding step, feeding steel balls in sequential order into the inspective system;

a first inspection step, making the steel balls produce eddy current, and analyzing physical properties of the steel balls by inspecting eddy current change of the steel balls;

a first discharging step, comparing the physical properties of the steel balls and controlling transportation paths for targeted and non-targeted steel balls;

a buffering step, arranging the qualified steel balls in sequential order;

a second inspection step, using an image pickup device to take and save pictures of surfaces of the targeted steel balls, and analyzing the saved pictures of the surfaces of the targeted steel balls; and

a second discharging step, controlling transportation paths for qualified and non-qualified steel balls.

To achieve the above objective, a steel ball inspection system for inspecting surfaces and physical properties of steel balls, comprises: a feeding device, a first inspection device and a second inspection device.

The feeding device serves to feed the steel balls into the inspection system.

The first inspection device includes a feeding port, a discharge member, an inspection section located between the feeding and discharge ports, and an inspector disposed at the inspection section. The feeding port is connected to the feeding device, the inspector is disposed at the inspection section to enable the steel balls to produce eddy current and serves to detect eddy current change of the steel balls and analyze the physical properties of the steel balls based on the eddy current change, and the discharge member includes a discharge port and a separating port. The second inspection device has a buffer device connected to the discharge port. The buffer device includes a buffer and a carrier, on a top surface of the carrier are formed a plurality of cavities. The buffer and the carrier cooperates with each other to make the steel balls fall into the cavities, the second inspection device further includes an image pickup device which takes pictures of and analyzes surfaces of the steel balls in the cavities.

### BRIEF DESCRIPTION OF THE DRAWINGS

FIG. 1 is a perspective view of a steel ball inspection method and system in accordance with a preferred embodiment of the present invention;

FIG. 2 is a side view of the steel ball inspection method and system in accordance with the present invention; and

FIG. 3 is a flow chart showing a steel ball inspection method in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIGS. 1-2, a steel ball inspection method and system in accordance with a preferred embodiment of the present invention are used to inspect the outer surface and the physical properties of a steel ball. The inspection system comprise: a feeding device 20, a first inspection device 30 and a second inspection device 40.

The feeding device 20 serves to feed steel balls into the inspection system and is in the form of a pipe structure whose inner diameter allows for passage of one steel ball at a time, so that the steel balls can be fed in sequential order into the inspective system. The feeding device 20 can also be provided with an oscillator which oscillates to enable the steel balls to be constantly fed into the feeding device 20. Since the oscillator is of conventional art and not the key feature of the present invention, further explanation would be omitted here.

The first inspection device 30 includes a feeding port 31, a discharge member 32, an inspection section 33 located between the feeding port 31 and the discharge member 32, and an inspector 34 disposed at the inspection section 33. The feeding port 31 is connected to the feeding device 20. The inspection section 33 is provided for carrying the steel balls and allows the steel balls to pass therethrough. The inspector 34 at the inspection section 33 enables the steel balls to produce eddy current and is provided with a plurality of probes 341 which are connected to an analyzer 342. Each of the probes 341 produces a specific magnetic field and detects the eddy current change of the steel balls when the steel balls pass through the magnetic field, so as to analyze the physical properties of the steel balls. Or, the data of the eddy current change detected by the probes 341 can be analyzed by the analyzer 342 to obtain the physical properties of the steel balls. The physical properties include the diameter, material and hardness, and etc of the steel ball. The probes 341 can be dual coil differential structure. When the probes 341 are close to the surface of the steel ball, and if there are defects, such as cracks, on the outer surface of the steel ball, the impedance of the steel ball will change, and so will the differential output, and thus a defect signal will be produced. The discharge member 32 includes a discharge port 321, a separating port 322 connected to the discharge port 321, and a separating rod 323 located between the discharge port 321 and the separating port 322. With the separating rod 323 opening and closing the discharge port 321 and the separating port 322, the steel ball transportation path can be controlled. For example, when a defect signal is produced, the separating rod 323 closes the discharge port 321 while opening the separating port 322, so that the defective steel ball can be removed from the inspection system by the separating port 322.

The second inspection device 40 has a buffer device 41 connected to the discharge port 321. The buffer device 41 includes a buffer 42 and a carrier 43. The carrier 43 includes a base 431 with a rolling groove, and a rotary disc 432 rotatably mounted on the base 431. On the top surface of the rotary disc 432 of the carrier 43 is formed a plurality of cavities 433. The buffer 42 and the carrier 43 cooperate with each other to make the steel balls fall into the cavities 433. The second inspection device 40 further has an image pickup device 44 which takes the picture of and analyzes the surface of the steel balls in the cavities 433. The image pickup device 44 can be a CCD lens or a camera. The second inspection device 40 is further provided with a selector 45 which is in the form of a lever disposed at the periphery of the carrier 43 to remove the steel balls from the cavities 433.

The abovementioned is the steel ball inspection system in accordance with a preferred embodiment of the present invention, and for the inspection method, please refer to FIGS. 1-3 again. The steel ball inspection method in accordance with the present invention comprises the following steps:

a, a feeding step 501: feeding steel balls in sequential order into the inspective system, wherein a pipe structure whose inner diameter allows for passage of one steel ball at a time enables the steel balls to be fed in sequential order into the inspective system, further, an oscillator which oscillates can be provided to enable the steel balls to be constantly fed into the feeding device;

b, a first inspection step 502: using an inspection device to make the steel balls produce eddy current, the inspection device includes an analyzer and serves to detect eddy current change of the steel balls and analyze physical properties of the steel balls, the data of the detected eddy current change can be analyzed by the analyzer as so to enable the analyzer to analyze the physical properties of the steel balls, the steel balls during inspection can rotate at a predetermined speed;

c, a first discharging step 503: comparing the physical properties of the steel balls and controlling the transportation paths for targeted and non-targeted steel balls, as shown in FIG. 1, this step is carried out by the discharge member 32 which includes a discharge port, a separating port 322 connected to the discharge port 321, and a separating rod 323 located between the discharge port 321 and the separating port 322. With the separating rod 323 opening and closing the discharge port 321 and the separating port 322, the steel ball transportation path can be controlled;

d, a buffering step 504: using the buffer 42 and the carrier 43 to make the targeted steel balls fall into the cavities 433 of the carrier 43 in a one-at-a-time fashion, and enabling the targeted steel balls to be arranged in sequential order;

e, a second inspection step 505: using a CCD lens or a camera to take and save the picture of the surface of the targeted steel balls, and analyzing the saved picture of the surface of the targeted steel balls; and

f, a second discharging step 506: controlling transportation paths for qualified and non-qualified steel balls, and this step can be carried out by a selector which is in the form of a lever disposed at the periphery of the carrier 43 to remove the qualified and non-qualified steel balls from the cavities 433.

While we have shown and described various embodiments in accordance with the present invention, it is clear to those skilled in the art that further embodiments may be made without departing from the scope of the present invention.

What is claimed is:

1. A steel ball inspection method comprising the following steps:
a feeding step, feeding steel balls in sequential order into the inspective system;
a first inspection step, making the steel balls produce eddy current, and analyzing physical properties of the steel balls by inspecting eddy current change of the steel balls;
a first discharging step, comparing the physical properties of the steel balls and controlling transportation paths for targeted and non-targeted steel balls;
a buffering step, arranging the qualified steel balls in sequential order;
a second inspection step, using an image pickup device to take and save pictures of surfaces of the targeted steel balls, and analyzing the saved pictures of the surfaces of the targeted steel balls; and
a second discharging step, controlling transportation paths for qualified and non-qualified steel balls.

2. The steel ball inspection method as claimed in claim 1, wherein an inspection device is used in the first inspection step to make the steel balls produce eddy current and includes a plurality of probes, and a CCD lens is used in the second inspection step to take the pictures of the surfaces of the steel balls.

3. The steel ball inspection method as claimed in claim 1, wherein a buffer and a carrier are used in the buffering step to make the targeted steel balls fall into the cavities of the carrier.

4. A steel ball inspection system for inspecting surfaces and physical properties of steel balls, comprising:
a feeding device for feeding the steel balls into the inspection system;
a first inspection device including a feeding port, a discharge member, an inspection section located between the feeding and discharge ports, and an inspector disposed at the inspection section, the feeding port being connected to the feeding device, the inspector being disposed at the inspection section to enable the steel balls to produce eddy current and serving to detect eddy current change of the steel balls and analyzing the physical properties of the steel balls based on the eddy current change, the discharge member including a discharge port and a separating port;
a second inspection device with a buffer device connected to the discharge port, the buffer device including a buffer and a carrier, on a top surface of the carrier being formed a plurality of cavities, the buffer and the carrier cooperating with each other to make the steel balls fall into the cavities, the second inspection device further including an image pickup device which takes pictures of and analyzes surfaces of the steel balls in the cavities.

5. The steel ball inspection system as claimed in claim 4, wherein the image pickup device is a CCD lens.

6. The steel ball inspection system as claimed in claim 4, wherein the second inspection device further includes a selector which is in the form of a lever disposed at a periphery of the carrier to remove the steel balls from the cavities.
